(19) United States
(12) Patent Application Publication
(10) Pub. No.: US 2015/0055376 A1
(43) Pub. Date: Feb. 26, 2015

(54) OPEN LOOP POWER CONVERSION APPARATUS

(71) Applicant: Chicony Power Technology Co., Ltd., New Taipei City (TW)

(72) Inventors: Wen-Nan HUANG, New Taipei City (TW); Shiu-Hui LEE, New Taipei City (TW)

(73) Assignee: Chicony Power Technology Co., Ltd., New Taipei City (TW)

(21) Appl. No.: 13/972,390

(22) Filed: Aug. 21, 2013

(51) Int. Cl. H02M 3/335

(52) U.S. Cl. CPC H02M 3/33569
USPC 363/21.02

(57) ABSTRACT

An open loop power conversion apparatus is applied to a load apparatus and an input power. The open loop power conversion apparatus outputs a predetermined voltage to the load apparatus. The open loop power conversion apparatus includes a resonant inductor, a magnetic inductor, a resonant capacitor, and a transformer. The resonant inductor has a non-uniform air gap. An inductance of the resonant inductor is decreasing when a current outputted from the open loop power conversion apparatus to the load apparatus is increasing. An output voltage gain of the open loop power conversion apparatus is increasing, so that the predetermined voltage is increasing.

### BACKGROUND OF THE INVENTION

1. Field of the Invention

The present invention relates to a power conversion apparatus, and especially relates to an open loop power conversion apparatus.

2. Description of the Related Art

A related art power conversion apparatus mainly includes a resonant inductor, a magnetic inductor, a resonant capacitor, a transformer and a feedback circuit. The feedback circuit includes a shunt regulator and a photo coupler.

The related art power conversion apparatus must include the feedback circuit because the resonant inductor of the related art power conversion apparatus has a uniform air gap. Therefore, the cost is increasing and the circuit design (changing frequency) is complicated.

### SUMMARY OF THE INVENTION

In order to solve the above-mentioned problems, an object of the present invention is to provide an open loop power conversion apparatus.

In order to achieve the object of the present invention mentioned above, the open loop power conversion apparatus is applied to a load apparatus and an input power. The open loop power conversion apparatus outputs a predetermined voltage to the load apparatus. The open loop power conversion apparatus includes a resonant inductor, a magnetic inductor, a resonant capacitor and a transformer. The resonant inductor has a non-uniform air gap. The magnetic inductor is electrically connected to the resonant inductor. The resonant capacitor is electrically connected to the magnetic inductor. The transformer includes a transformer primary side and a transformer secondary side. The transformer primary side is electrically connected to the resonant inductor, the magnetic inductor and the resonant capacitor. The transformer secondary side is electrically connected to the load apparatus. An inductance of the resonant inductor is decreasing when a current outputted from the open loop power conversion apparatus to the load apparatus is increasing. An output voltage gain of the open loop power conversion apparatus is increasing, so that the predetermined voltage is increasing.

Moreover, the open loop power conversion apparatus further includes a first switch unit electrically connected to the input power and the resonant inductor.

Moreover, the open loop power conversion apparatus further includes a second switch unit electrically connected to the input power, the resonant inductor, the first switch unit and the resonant capacitor.

Moreover, the open loop power conversion apparatus further includes a switch control unit electrically connected to the first switch unit and the second switch unit.

Moreover, the open loop power conversion apparatus further includes a first diode electrically connected to the transformer secondary side and the load apparatus.

Moreover, the open loop power conversion apparatus further includes an output side capacitor electrically connected to the first diode, the load apparatus and the transformer secondary side.

Moreover, the transformer further includes an auxiliary winding electrically connected to the transformer secondary side, the output side capacitor and the load apparatus.

Moreover, the open loop power conversion apparatus further includes a second diode electrically connected to the auxiliary winding, the first diode, the output side capacitor and the load apparatus.

Moreover, the first switch unit is a metal oxide semiconductor field effect transistor, an insulation gate bipolar transistor, a silicon controlled rectifier or a bipolar junction transistor. The second switch unit is a metal oxide semiconductor field effect transistor, an insulation gate bipolar transistor, a silicon controlled rectifier or a bipolar junction transistor.

Moreover, the transformer is a flyback transformer, a forward transformer, an inductor-inductor-capacitor resonant transformer or a push pull transformer.

### BRIEF DESCRIPTION OF DRAWING

FIG. 1 shows a block diagram of the open loop power conversion apparatus of the present invention.

### DETAILED DESCRIPTION OF THE INVENTION

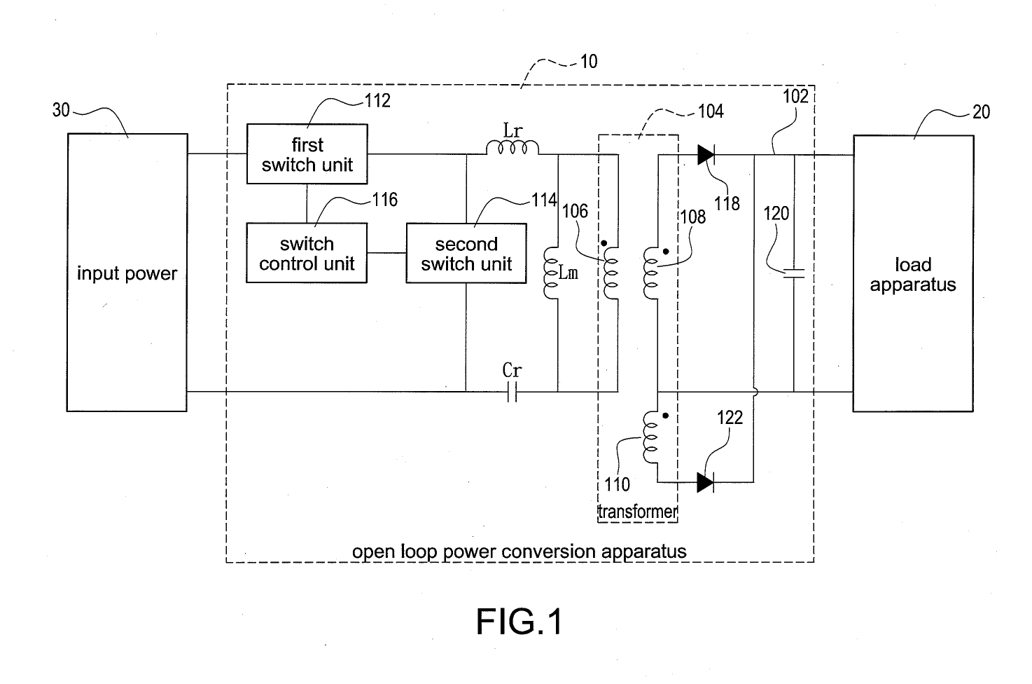

FIG. 1 shows a block diagram of the open loop power conversion apparatus of the present invention. An open loop power conversion apparatus 10 is applied to a load apparatus 20 and an input power 30. The open loop power conversion apparatus 10 outputs a predetermined voltage 102 to the load apparatus 20.

The open loop power conversion apparatus 10 includes a resonant inductor Lr, a magnetic inductor Lm, a resonant capacitor Cr, a transformer 104, a first switch unit 112, a second switch unit 114, a switch control unit 116, a first diode 118, an output side capacitor 120 and a second diode 122.

The transformer 104 includes a transformer primary side 106, a transformer secondary side 108 and an auxiliary winding 110. The resonant inductor Lr has a non-uniform air gap.

The magnetic inductor Lm is electrically connected to the resonant inductor Lr. The resonant capacitor Cr is electrically connected to the magnetic inductor Lm. The first switch unit 112 is electrically connected to the input power 30 and the resonant inductor Lr. The second switch unit 114 is electrically connected to the input power 30, the resonant inductor Lr, the first switch unit 112 and the resonant capacitor Cr. The switch control unit 116 is electrically connected to the first switch unit 112 and the second switch unit 114.

The first diode 118 is electrically connected to the transformer secondary side 108 and the load apparatus 20. The output side capacitor 120 is electrically connected to the first diode 118, the load apparatus 20 and the transformer secondary side 108. The second diode 122 is electrically connected to the auxiliary winding 110, the first diode 118, the output side capacitor 120 and the load apparatus 20.

The transformer primary side 106 is electrically connected to the resonant inductor Lr, the magnetic inductor Lm and the resonant capacitor Cr. The transformer secondary side 108 is electrically connected to the load apparatus 20. The auxiliary winding 110 is electrically connected to the transformer secondary side 108, the output side capacitor 120 and the load apparatus 20.

The first switch unit 112 is a metal oxide semiconductor field effect transistor, an insulation gate bipolar transistor, a silicon controlled rectifier or a bipolar junction transistor. The second switch unit 114 is a metal oxide semiconductor field effect transistor, an insulation gate bipolar transistor, a silicon controlled rectifier or a bipolar junction transistor. The transformer 104 is a flyback transformer, a forward transformer, an inductor-inductor-capacitor resonant transformer or a push pull transformer.

An inductance of the resonant inductor Lr is decreasing when a current outputted from the open loop power conversion apparatus 10 to the load apparatus 20 is increasing (because the resonant inductor Lr has the non-uniform air gap). An output voltage gain of the open loop power conversion apparatus 10 is increasing, so that the predetermined voltage 102 is increasing. Therefore, the open loop power conversion apparatus 10 of the present invention is achieved.

The feature of the present invention is that the resonant inductor Lr has the non-uniform air gap. Therefore, the feedback circuit of the related art power conversion apparatus is not required. The cost is decreasing and the circuit design (fixing frequency) is simple.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An open loop power conversion apparatus applied to a load apparatus and an input power, the open loop power conversion apparatus outputting a predetermined voltage to the load apparatus, the open loop power conversion apparatus comprising:
a resonant inductor having a non-uniform air gap;
a magnetic inductor electrically connected to the resonant inductor;
a resonant capacitor electrically connected to the magnetic inductor; and
a transformer having a transformer primary side and a transformer secondary side, the transformer primary side electrically connected to the resonant inductor, the magnetic inductor and the resonant capacitor, the transformer secondary side electrically connected to the load apparatus,
wherein an inductance of the resonant inductor is decreasing and an output voltage gain of the open loop power conversion apparatus is increasing when a current outputted from the open loop power conversion apparatus to the load apparatus is increasing; whereby the predetermined voltage is increasing.

2. The open loop power conversion apparatus in claim 1, further including a first switch unit electrically connected to the input power and the resonant inductor.

3. The open loop power conversion apparatus in claim 2, further including a second switch unit electrically connected to the input power, the resonant inductor, the first switch unit and the resonant capacitor.

4. The open loop power conversion apparatus in claim 3, further including a switch control unit electrically connected to the first switch unit and the second switch unit.

5. The open loop power conversion apparatus in claim 4, further including a first diode electrically connected to the transformer secondary side and the load apparatus.

6. The open loop power conversion apparatus in claim 5, further including an output side capacitor electrically connected to the first diode, the load apparatus and the transformer secondary side.

7. The open loop power conversion apparatus in claim 6, wherein the transformer further includes an auxiliary winding electrically connected to the transformer secondary side, the output side capacitor and the load apparatus.

8. The open loop power conversion apparatus in claim 7, further including a second diode electrically connected to the auxiliary winding, the first diode, the output side capacitor and the load apparatus.

9. The open loop power conversion apparatus in claim 8, wherein the first switch unit is a metal oxide semiconductor field effect transistor, an insulation gate bipolar transistor, a silicon controlled rectifier or a bipolar junction transistor; the second switch unit is a metal oxide semiconductor field effect transistor, an insulation gate bipolar transistor, a silicon controlled rectifier or a bipolar junction transistor.

10. The open loop power conversion apparatus in claim 9, wherein the transformer is a flyback transformer, a forward transformer, an inductor-inductor-capacitor resonant transformer or a push pull transformer.
